(19) United States
(12) Patent Application Publication
(10) Pub. No.: US 2009/0210789 A1
(43) Pub. Date: Aug. 20, 2009

(54) TECHNIQUES TO GENERATE A VISUAL COMPOSITION FOR A MULTIMEDIA CONFERENCE EVENT

(75) Inventors: Pulin Thakkar, Redmond, WA (US); Noor-E-Gagan Singh, Redmond, WA (US); Stuti Jain, Redmond, WA (US); IX, Austin, TX (US); Avronil Bhattacharjee, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/030,872

(22) Filed: Feb. 14, 2008

(51) Int. Cl. G06F 3/00; G06F 3/01

(52) U.S. Cl. 715/719; 715/753

(57) ABSTRACT

Techniques to generate a visual composition for a multimedia conference event are described. An apparatus may comprise a visual composition component operative to generate a visual composition for a multimedia conference event. The visual composition component may comprise a video decoder module operative to decode multiple media streams for a multimedia conference event, an active speaker detector module operative to detect a participant in a decoded media stream as an active speaker, a media stream manager module operative to map the decoded media stream with the active speaker to an active display frame and the other decoded media streams to non-active display frames, and a visual composition generator module operative to generate a visual composition with a participant roster having the active and non-active display frames positioned in a predetermined order. Other embodiments are described and claimed.

### BACKGROUND

A multimedia conferencing system typically allows multiple participants to communicate and share different types of media content in a collaborative and real-time meeting over a network. The multimedia conferencing system may display different types of media content using various graphical user interface (GUI) windows or views. For example, one GUI view might include video images of participants, another GUI view might include presentation slides, yet another GUI view might include text messages between participants, and so forth. In this manner various geographically disparate participants may interact and communicate information in a virtual meeting environment similar to a physical meeting environment where all the participants are within one room.

In a virtual meeting environment, however, it may be difficult to identify the various participants of a meeting. This problem typically increases as the number of meeting participants increase, thereby potentially leading to confusion and awkwardness among the participants. Furthermore, it may be difficult to identify a particular speaker at any given moment in time, particularly when multiple participants are speaking simultaneously or in rapid sequence. Techniques directed to improving identification techniques in a virtual meeting environment may enhance user experience and convenience.

### SUMMARY

Various embodiments may be generally directed to multimedia conference systems. Some embodiments may be particularly directed to techniques to generate a visual composition for a multimedia conference event. The multimedia conference event may include multiple participants, some of which may gather in a conference room, while others may participate in the multimedia conference event from a remote location.

In one embodiment, for example, an apparatus such as a meeting console may comprise a display and a visual composition component operative to generate a visual composition for a multimedia conference event. The visual composition component may comprise a video decoder module operative to decode multiple media streams for a multimedia conference event. The visual composition component may further comprise an active speaker detector module communicatively coupled to the video decoder module, the active speaker detector module operative to detect a participant in a decoded media stream as an active speaker. The visual composition component may still further comprise a media stream manager module communicatively coupled to the active speaker detector module, the media stream manager module operative to map the decoded media stream with the active speaker to an active display frame and the other decoded media streams to non-active display frames. The visual composition component may yet further comprise a visual composition generator module communicatively coupled to the media stream manager module, the visual composition generator module operative to generate a visual composition with a participant roster having the active and non-active display frames positioned in a predetermined order. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an embodiment of a multimedia conferencing system.

FIG. 2 illustrates an embodiment of a visual composition component.

FIG. 3 illustrates an embodiment of a visual composition.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments may be generally directed to multimedia conferencing systems arranged to provide meeting and collaboration services to multiple participants over a network. Some multimedia conferencing systems may be designed to operate with various packet-based networks, such as the Internet or World Wide Web (“web”), to provide web-based conferencing services. Such implementations are sometimes referred to as web conferencing systems. An example of a web conferencing system may include MICROSOFT® OFFICE LIVE MEETING made by Microsoft Corporation, Redmond, Wash. Other multimedia conferencing systems may be designed to operate for a private network, business, organization, or enterprise, and may utilize a multimedia conferencing server such as MICROSOFT OFFICE COMMUNICATIONS SERVER made by Microsoft Corporation, Redmond, Wash. It may be appreciated, however, that implementations are not limited to these examples.

A multimedia conferencing system may include, among other network elements, a multimedia conferencing server or other processing device arranged to provide web conferencing services. For example, a multimedia conferencing server may include, among other server elements, a server meeting component operative to control and mix different types of media content for a meeting and collaboration event, such as a web conference. A meeting and collaboration event may refer to any multimedia conference event offering various types of multimedia information in a real-time or live online environment, and is sometimes referred to herein as simply a “meeting event,” “multimedia event” or “multimedia conference event.”

In one embodiment, the multimedia conferencing system may further include one or more computing devices implemented as meeting consoles. Each meeting console may be arranged to participate in a multimedia event by connecting to the multimedia conference server. Different types of media information from the various meeting consoles may be received by the multimedia conference server during the multimedia event, which in turn distributes the media information to some or all of the other meeting consoles participating in the multimedia event As such, any given meeting console may have a display with multiple media content views of different types of media content. In this manner various geographically disparate participants may interact and communicate information in a virtual meeting environment similar to a physical meeting environment where all the participants are within one room.

In a virtual meeting environment, it may be difficult to identify the various participants of a meeting. Participants in a multimedia conference event are typically listed in a GUI view with a participant roster. The participant roster may have some identifying information for each participant, including a name, location, image, title, and so forth. The participants and identifying information for the participant roster is typically derived from a meeting console used to join the multimedia conference event. For example, a participant typically uses a meeting console to join a virtual meeting room for a multimedia conference event. Prior to joining, the participant provides various types of identifying information to perform authentication operations with the multimedia conferencing server. Once the multimedia conferencing server authenticates the participant, the participant is allowed access to the virtual meeting room, and the multimedia conferencing server adds the identifying information to the participant roster.

The identifying information displayed by the participant roster, however, is typically disconnected from any video content of the actual participants in a multimedia conference event. For example, the participant roster and corresponding identifying information for each participant is typically shown in a separate GUI view from the other GUI views with multimedia content. There is no direct mapping between a participant from the participant roster and an image of the participant in the streaming video content. Consequently, it sometimes becomes difficult to map video content for a participant in a GUI view to a particular set of identifying information in the participant roster.

Furthermore, it may be difficult to identify a particular active speaker at any given moment in time, particularly when multiple participants are speaking simultaneously or in rapid sequence. This problem is exacerbated when there is no direct link between identifying information for a participant and video content for a participant. The viewer may not be able to readily identify which particular GUI view has a currently active speaker, and therefore hindering natural discourse with the other participants in the virtual meeting room.

To solve these and other problems, some embodiments are directed to techniques to generate a visual composition for a multimedia conference event. More particularly, certain embodiments are directed to techniques to generate a visual composition that provides a more natural representation for meeting participants in the digital domain. The visual composition integrates and aggregates different types of multimedia content related to each participant in a multimedia conference event, including video content, audio content, identifying information, and so forth. The visual composition presents the integrated and aggregated information in a manner that allows a viewer to focus on a particular region of the visual composition to gather participant specific information for one participant, and another particular region to gather participant specific information for another participant, and so forth. In this manner, the viewer may focus on the interactive portions of the multimedia conference event, rather than spending time gathering participant information from disparate sources. As a result, the visual composition technique can improve affordability, scalability, modularity, extendibility, or interoperability for an operator, device or network.

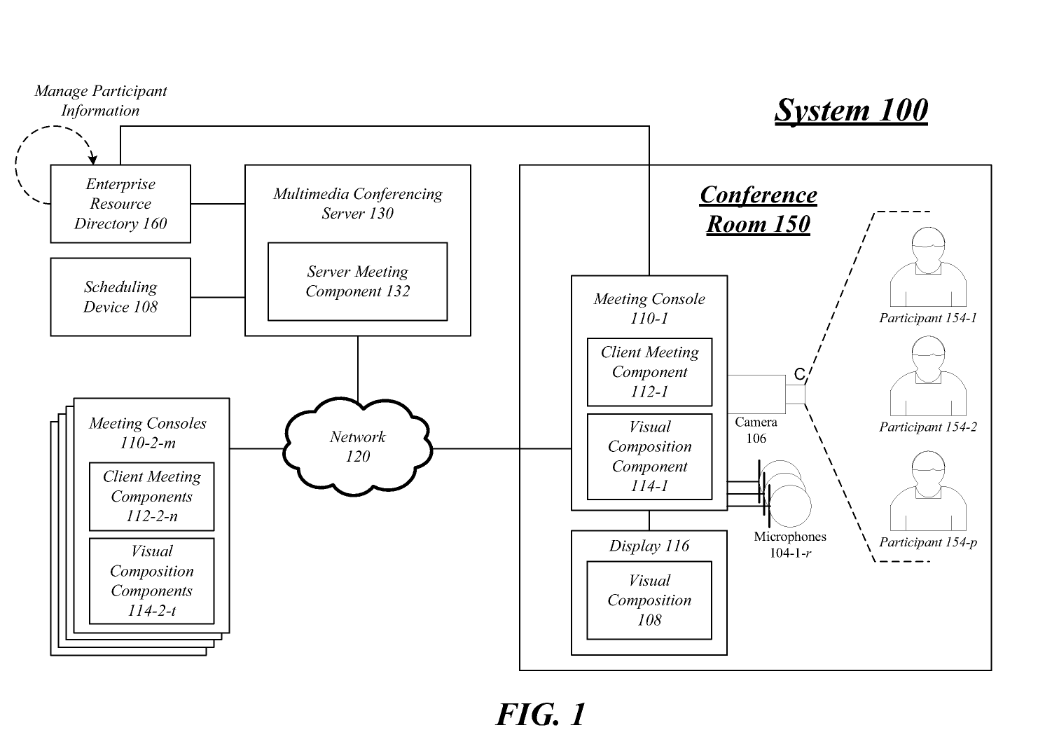

FIG. 1 illustrates a block diagram for a multimedia conferencing system 100. Multimedia conferencing system 100 may represent a general system architecture suitable for implementing various embodiments. Multimedia conferencing system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although multimedia conferencing system 100 as shown in FIG. 1 has a limited number of elements in a certain topology, it may be appreciated that multimedia conferencing system 100 may include more or less elements in alternate topologies as desired for a given implementation. The embodiments are not limited in this context.

In various embodiments, the multimedia conferencing system 100 may comprise, or form part of, a wired communications system, a wireless communications system, or a combination of both. For example, the multimedia conferencing system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The multimedia conferencing system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

In various embodiments, the multimedia conferencing system 100 may be arranged to communicate, manage or process different types of information, such as media information and control information. Examples of media information may generally include any data representing content meant for a user, such as voice information, video information, audio information, image information, textual information, numerical information, application information, alphanumeric symbols, graphics, and so forth. Media information may sometimes be referred to as “media content” as well. Control information may refer to any data representing commands, instructions or control words meant for an automated system. For example, control information may be used to route media information through a system, to establish a connection between devices, instruct a device to process the media information in a predetermined manner, and so forth.

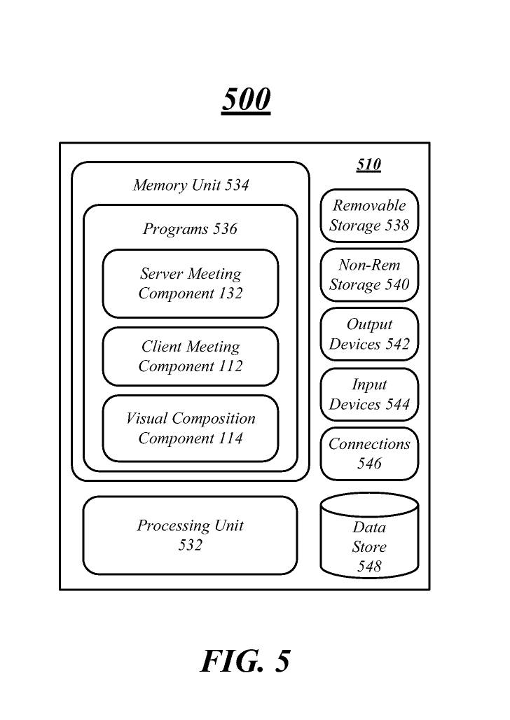

In various embodiments, multimedia conferencing system 100 may include a multimedia conferencing server 130. The multimedia conferencing server 130 may comprise any logical or physical entity that is arranged to establish, manage or control a multimedia conference call between meeting consoles 110-1-m over a network 120. Network 120 may comprise, for example, a packet-switched network, a circuit-switched network, or a combination of both. In various embodiments, the multimedia conferencing server 130 may comprise or be implemented as any processing or computing device, such as a computer, a server, a server array or server farm, a work station, a mini-computer, a main frame computer, a supercomputer, and so forth. The multimedia conferencing server 130 may comprise or implement a general or specific computing architecture suitable for communicating and processing multimedia information. In one embodiment, for example, the multimedia conferencing server 130 may be implemented using a computing architecture as described with reference to FIG. 5. Examples for the multimedia conferencing server 130 may include without limitation a MICROSOFT OFFICE COMMUNICATIONS SERVER, a MICROSOFT OFFICE LIVE MEETING server, and so forth.

A specific implementation for the multimedia conferencing server 130 may vary depending upon a set of communication protocols or standards to be used for the multimedia conferencing server 130. In one example, the multimedia conferencing server 130 may be implemented in accordance with the Internet Engineering Task Force (IETF) Multiparty Multimedia Session Control (MMUSIC) Working Group Session Initiation Protocol (SIP) series of standards and/or variants. SIP is a proposed standard for initiating, modifying, and terminating an interactive user session that involves multimedia elements such as video, voice, instant messaging, online games, and virtual reality. In another example, the multimedia conferencing server 130 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. Both the SIP and H.323 standards are essentially signaling protocols for Voice over Internet Protocol (VoIP) or Voice Over Packet (VOP) multimedia conference call operations. It may be appreciated that other signaling protocols may be implemented for the multimedia conferencing server 130, however, and still fall within the scope of the embodiments.

In general operation, multimedia conferencing system 100 may be used for multimedia conferencing calls. Multimedia conferencing calls typically involve communicating voice, video, and/or data information between multiple end points. For example, a public or private packet network 120 may be used for audio conferencing calls, video conferencing calls, audio/video conferencing calls, collaborative document sharing and editing, and so forth. The packet network 120 may also be connected to a Public Switched Telephone Network (PSTN) via one or more suitable VoIP gateways arranged to convert between circuit-switched information and packet information.

To establish a multimedia conferencing call over the packet network 120, each meeting console 110-1-m may connect to multimedia conferencing server 130 via the packet network 120 using various types of wired or wireless communications links operating at varying connection speeds or bandwidths, such as a lower bandwidth PSTN telephone connection, a medium bandwidth DSL modem connection or cable modem connection, and a higher bandwidth intranet connection over a local area network (LAN), for example.

In various embodiments, the multimedia conferencing server 130 may establish, manage and control a multimedia conference call between meeting consoles 110-1-m. In some embodiments, the multimedia conference call may comprise a live web-based conference call using a web conferencing application that provides full collaboration capabilities. The multimedia conferencing server 130 operates as a central server that controls and distributes media information in the conference. It receives media information from various meeting consoles 110-1-m, performs mixing operations for the multiple types of media information, and forwards the media information to some or all of the other participants. One or more of the meeting consoles 110-1-m may join a conference by connecting to the multimedia conferencing server 130. The multimedia conferencing server 130 may implement various admission control techniques to authenticate and add meeting consoles 110-1-m in a secure and controlled manner.

In various embodiments, the multimedia conferencing system 100 may include one or more computing devices implemented as meeting consoles 110-1-m to connect to the multimedia conferencing server 130 over one or more communications connections via the network 120. For example, a computing device may implement a client application that may host multiple meeting consoles each representing a separate conference at the same time. Similarly, the client application may receive multiple audio, video and data streams. For example, video streams from all or a subset of the participants may be displayed as a mosaic on the participant's display with a top window with video for the current active speaker, and a panoramic view of the other participants in other windows.

The meeting consoles 110-1-m may comprise any logical or physical entity that is arranged to participate or engage in a multimedia conferencing call managed by the multimedia conferencing server 130. The meeting consoles 110-1-m may be implemented as any device that includes, in its most basic form, a processing system including a processor and memory, one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of the meeting consoles 110-1-m may include a telephone, a VoIP or VOP telephone, a packet telephone designed to operate on the PSTN, an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. In some implementations, the meeting consoles 110-1-m may be implemented using a general or specific computing architecture similar to the computing architecture described with reference to FIG. 5.

The meeting consoles 110-1-m may comprise or implement respective client meeting components 112-1-n. The client meeting components 112-1-n may be designed to interoperate with the server meeting component 132 of the multimedia conferencing server 130 to establish, manage or control a multimedia conferencing event. For example, the client meeting components 112-1-n may comprise or implement the appropriate application programs and user interface controls to allow the respective meeting consoles 110-1-m to participate in a web conference facilitated by the multimedia conferencing server 130. This may include input equipment (e.g., video camera, microphone, keyboard, mouse, controller, etc.) to capture media information provided by the operator of a meeting console 110-1-m, and output equipment (e.g., display, speaker, etc.) to reproduce media information by the operators of other meeting consoles 110-1-m. Examples for client meeting components 112-1-n may include without limitation a MICROSOFT OFFICE COMMUNICATOR or the MICROSOFT OFFICE LIVE MEETING Windows Based Meeting Console, and so forth.

As shown in the illustrated embodiment of FIG. 1, the multimedia conference system 100 may include a conference room 150. An enterprise or business typically utilizes conference rooms to hold meetings. Such meetings include multimedia conference events having participants located internal to the conference room 150, and remote participants located external to the conference room 150. The conference room 150 may have various computing and communications resources available to support multimedia conference events, and provide multimedia information between one or more remote meeting consoles 110-2-m and the local meeting console 110-1. For example, the conference room 150 may include a local meeting console 110-1 located internal to the conference room 150.

The local meeting console 110-1 may be connected to various multimedia input devices and/or multimedia output devices capable of capturing, communicating or reproducing multimedia information. The multimedia input devices may comprise any logical or physical device arranged to capture or receive as input multimedia information from operators within the conference room 150, including audio input devices, video input devices, image input devices, text input devices, and other multimedia input equipment. Examples of multimedia input devices may include without limitation video cameras, microphones, microphone arrays, conference telephones, whiteboards, interactive whiteboards, voice-to-text components, text-to-voice components, voice recognition systems, pointing devices, keyboards, touchscreens, tablet computers, handwriting recognition devices, and so forth. An example of a video camera may include a ringcam, such as the MICROSOFT ROUNDTABLE made by Microsoft Corporation, Redmond, Wash. The MICROSOFT ROUNDTABLE is a videoconferencing device with a 360 degree camera that provides remote meeting participants a panoramic video of everyone sitting around a conference table. The multimedia output devices may comprise any logical or physical device arranged to reproduce or display as output multimedia information from operators of the remote meeting consoles 110-2-m, including audio output devices, video output devices, image output devices, text input devices, and other multimedia output equipment. Examples of multimedia output devices may include without limitation electronic displays, video projectors, speakers, vibrating units, printers, facsimile machines, and so forth.

The local meeting console 110-1 in the conference room 150 may include various multimedia input devices arranged to capture media content from the conference room 150 including the participants 154-1-p, and stream the media content to the multimedia conferencing server 130. In the illustrated embodiment shown in FIG. 1, the local meeting console 110-1 includes a video camera 106 and an array of microphones 104-1-r. The video camera 106 may capture video content including video content of the participants 154-1-p present in the conference room 150, and stream the video content to the multimedia conferencing server 130 via the local meeting console 110-1. Similarly, the array of microphones 104-1-r may capture audio content including audio content from the participants 154-1-p present in the conference room 150, and stream the audio content to the multimedia conferencing server 130 via the local meeting console 110-1. The local meeting console may also include various media output devices, such as a display 116 or video projector, to show one or more GUI views with video content or audio content from all the participants using the meeting consoles 110-1-m received via the multimedia conferencing server 130.

The meeting consoles 110-1-m and the multimedia conferencing server 130 may communicate media information and control information utilizing various media connections established for a given multimedia conference event. The media connections may be established using various VoIP signaling protocols, such as the SIP series of protocols. The SIP series of protocols are application-layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP is designed as part of the overall IETF multimedia data and control architecture currently incorporating protocols such as the resource reservation protocol (RSVP) (IEEE RFC 2205) for reserving network resources, the real-time transport protocol (RTP) (IEEE RFC 1889) for transporting real-time data and providing Quality-of-Service (QOS) feedback, the real-time streaming protocol (RTSP) (IEEE RFC 2326) for controlling delivery of streaming media, the session announcement protocol (SAP) for advertising multimedia sessions via multicast, the session description protocol (SDP) (IEEE RFC 2327) for describing multimedia sessions, and others. For example, the meeting consoles 110-1-m may use SIP as a signaling channel to setup the media connections, and RTP as a media channel to transport media information over the media connections.

In general operation, a schedule device 108 may be used to generate a multimedia conference event reservation for the multimedia conferencing system 100. The scheduling device 108 may comprise, for example, a computing device having the appropriate hardware and software for scheduling multimedia conference events. For example, the scheduling device 108 may comprise a computer utilizing MICROSOFT OFFICE OUTLOOK® application software, made by Microsoft Corporation, Redmond, Wash. The MICROSOFT OFFICE OUTLOOK application software comprises messaging and collaboration client software that may be used to schedule a multimedia conference event. An operator may use MICROSOFT OFFICE OUTLOOK to convert a schedule request to a MICROSOFT OFFICE LIVE MEETING event that is sent to a list of meeting invitees. The schedule request may include a hyperlink to a virtual room for a multimedia conference event. An invitee may click on the hyperlink, and the meeting console 110-1-m launches a web browser, connects to the multimedia conferencing server 130, and joins the virtual room. Once there, the participants can present a slide presentation, annotate documents or brainstorm on the built in whiteboard, among other tools.

An operator may use the scheduling device 108 to generate a multimedia conference event reservation for a multimedia conference event. The multimedia conference event reservation may include a list of meeting invitees for the multimedia conference event. The meeting invitee list may comprise a list of individuals invited to a multimedia conference event. In some cases, the meeting invitee list may only include those individuals invited and accepted for the multimedia event. A client application, such as a mail client for Microsoft Outlook, forwards the reservation request to the multimedia conferencing server 130. The multimedia conferencing server 130 may receive the multimedia conference event reservation, and retrieve the list of meeting invitees and associated information for the meeting invitees from a network device, such as an enterprise resource directory 160.

The enterprise resource directory 160 may comprise a network device that publishes a public directory of operators and/or network resources. A common example of network resources published by the enterprise resource directory 160 includes network printers. In one embodiment, for example, the enterprise resource directory 160 may be implemented as a MICROSOFT ACTIVE DIRECTORY®. Active Directory is an implementation of lightweight directory access protocol (LDAP) directory services to provide central authentication and authorization services for network computers. Active Directory also allows administrators to assign policies, deploy software, and apply critical updates to an organization. Active Directory stores information and settings in a central database. Active Directory networks can vary from a small installation with a few hundred objects, to a large installation with millions of objects.

In various embodiments, the enterprise resource directory 160 may include identifying information for the various meeting invitees to a multimedia conference event. The identifying information may include any type of information capable of uniquely identifying each of the meeting invitees. For example, the identifying information may include without limitation a name, a location, contact information, account numbers, professional information, organizational information (e.g., a title), personal information, connection information, presence information, a network address, a media access control (MAC) address, an Internet Protocol (IP) address, a telephone number, an email address, a protocol address (e.g., SIP address), equipment identifiers, hardware configurations, software configurations, wired interfaces, wireless interfaces, supported protocols, and other desired information.

The multimedia conferencing server 130 may receive the multimedia conference event reservation, including the list of meeting invitees, and retrieves the corresponding identifying information from the enterprise resource directory 160. The multimedia conferencing server 130 may use the list of meeting invitees and corresponding identifying information to assist in automatically identifying the participants to a multimedia conference event. For example, the multimedia conferencing server 130 may forward the list of meeting invitees and accompanying identifying information to the meeting consoles 110-1-m for use in identifying the participants in a visual composition for the multimedia conference event.

Referring again to the meeting consoles 110-1-m, each of the meeting controls 110-1-m may comprise or implement respective visual composition components 114-1-t. The visual composition components 114-1-t may generally operate to generate and display a visual composition 108 for a multimedia conference event on a display 116. Although the visual composition 108 and display 116 are shown as part of the meeting console 110-1 by way of example and not limitation, it may be appreciated that each of the meeting consoles 110-1-m may include an electronic display similar to the display 116 and capable of rendering the visual composition 108 for each operator of the meeting consoles 110-1-m.

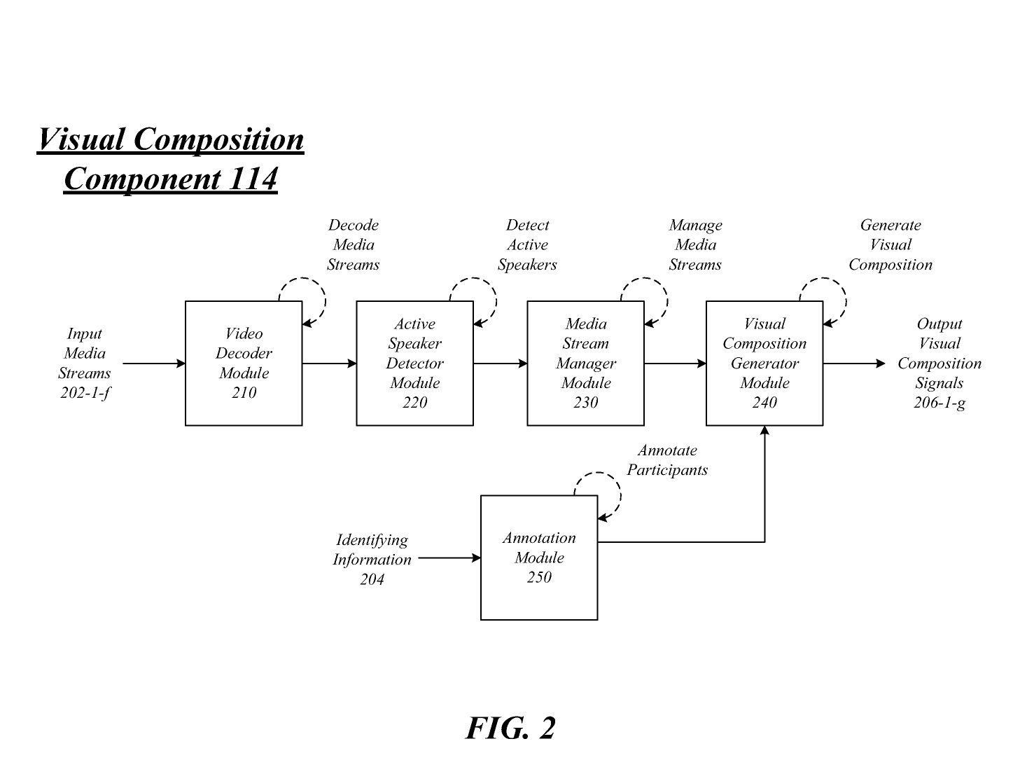

In one embodiment, for example, the local meeting console 110-1 may comprise the display 116 and the visual composition component 114-1 operative to generate a visual composition 108 for a multimedia conference event. The visual composition component 114-1 may comprise various hardware elements and/or software elements arranged to generate the visual composition 108 that provides a more natural representation for meeting participants (e.g., 154-1-p) in the digital domain. The visual composition 108 integrates and aggregates different types of multimedia content related to each participant in a multimedia conference event, including video content, audio content, identifying information, and so forth. The visual composition presents the integrated and aggregated information in a manner that allows a viewer to focus on a particular region of the visual composition to gather participant specific information for one participant, and another particular region to gather participant specific information for another participant, and so forth. In this manner, the viewer may focus on the interactive portions of the multimedia conference event, rather than spending time gathering participant information from disparate sources. The meeting consoles 110-1-m in general, and the visual composition component 114 in particular, may be described in more detail with reference to FIG. 2.

FIG. 2 illustrates a block diagram for the visual composition components 114-1-t. The visual composition component 114 may comprise multiple modules. The modules may be implemented using hardware elements, software elements, or a combination of hardware elements and software elements. Although the visual composition component 114 as shown in FIG. 2 has a limited number of elements in a certain topology, it may be appreciated that the visual composition component 114 may include more or less elements in alternate topologies as desired for a given implementation. The embodiments are not limited in this context.

In the illustrated embodiment shown in FIG. 2, the visual composition component 114 includes a video decoder module 210. The video decoder 210 may generally decode media streams received from various meeting consoles 110-1-m via the multimedia conferencing server 130. In one embodiment, for example, the video decoder module 210 may be arranged to receive input media streams 202-1-f from various meeting consoles 110-1-m participating in a multimedia conference event. The video decoder module 210 may decode the input media streams 202-1-f into digital or analog video content suitable for display by the display 116. Further, the video decoder module 210 may decode the input media streams 202-1-f into various spatial resolutions and temporal resolutions suitable for the display 116 and the display frames used by the visual composition 108.

The visual composition component 114-1 may comprise an active speaker detector module (ASD) module 220 communicatively coupled to the video decoder module 210. The ASD module 220 may generally detect whether any participants in the decoded media streams 202-1-f are active speakers. Various active speaker detection techniques may be implemented for the ASD module 220. In one embodiment, for example, the ASD module 220 may detect and measure voice energy in a decoded media stream, rank the measurements according to highest voice energy to lowest voice energy, and select the decoded media stream with the highest voice energy as representing the current active speaker. Other ASD techniques may be used, however, and the embodiments are not limited in this context.

In some cases, however, it may be possible for an input media stream 202-1-f to contain more than one participant, such as the input media stream 202-1 from the local meeting console 110-1 located in the conference room 150. In this case, the ASD module 220 may be arranged to detect dominant or active speakers from among the participants 154-1-p located in the conference room 150 using audio (sound source localization) and video (motion and spatial patterns) features. The ASD module 220 may determine the dominant speaker in the conference room 150 when several people are talking at the same time. It also compensates for background noises and hard surfaces that reflect sound. For example, the ASD module 220 may receive inputs from six separate microphones 104-1-r to differentiate between different sounds and isolate the dominant one through a process called beamforming. Each of the microphones 104-1-r is built into a different part of the meeting console 110-1. Despite the speed of sound, the microphones 104-1-r may receive voice information from the participants 154-1-p at different time intervals relative to each other. The ASD module 220 may use this time difference to identify a source for the voice information. Once the source for the voice information is identified, a controller for the local meeting console 110-1 may use visual cues from the video camera 106-1-p to pinpoint, enlarge and emphasize the face of the dominant speaker. In this manner, the ASD module 220 of the local meeting console 110-1 isolates a single participant 154-1-p from the conference room 150 as the active speaker on the transmit side.

The visual composition component 114-1 may comprise a media stream manager (MSM) module 230 communicatively coupled to the ASD module 220. The MSM module 230 may generally map decoded media streams to various display frames. In one embodiment, for example, the MSM module 230 may be arranged to map the decoded media stream with the active speaker to an active display frame, and the other decoded media streams to non-active display frames.

The visual composition component 114-1 may comprise a visual composition generator (VCG) module 240 communicatively coupled to the MSM module 230. The VCG module 240 may generally render or generate the visual composition 108. In one embodiment, for example, the VCG module 240 may be arranged to generate the visual composition 108 with a participant roster having the active and non-active display frames positioned in a predetermined order. The VCG module 240 may output visual composition signals 206-1-g to the display 116 via a video graphics controller and/or GUI module of an operating system for a given meeting console 110-1-m.

The visual composition component 114-1 may comprise an annotation module 250 communicatively coupled to the VCG module 240. The annotation module 250 may generally annotate participants with identifying information. In one embodiment, for example, the annotation module 250 may be arranged to receive an operator command to annotate a participant in an active or non-active display frame with identifying information. The annotation module 250 may determine an identifying location to position the identifying information. The annotation module 250 may then annotate the participant with identifying information at the identifying location.

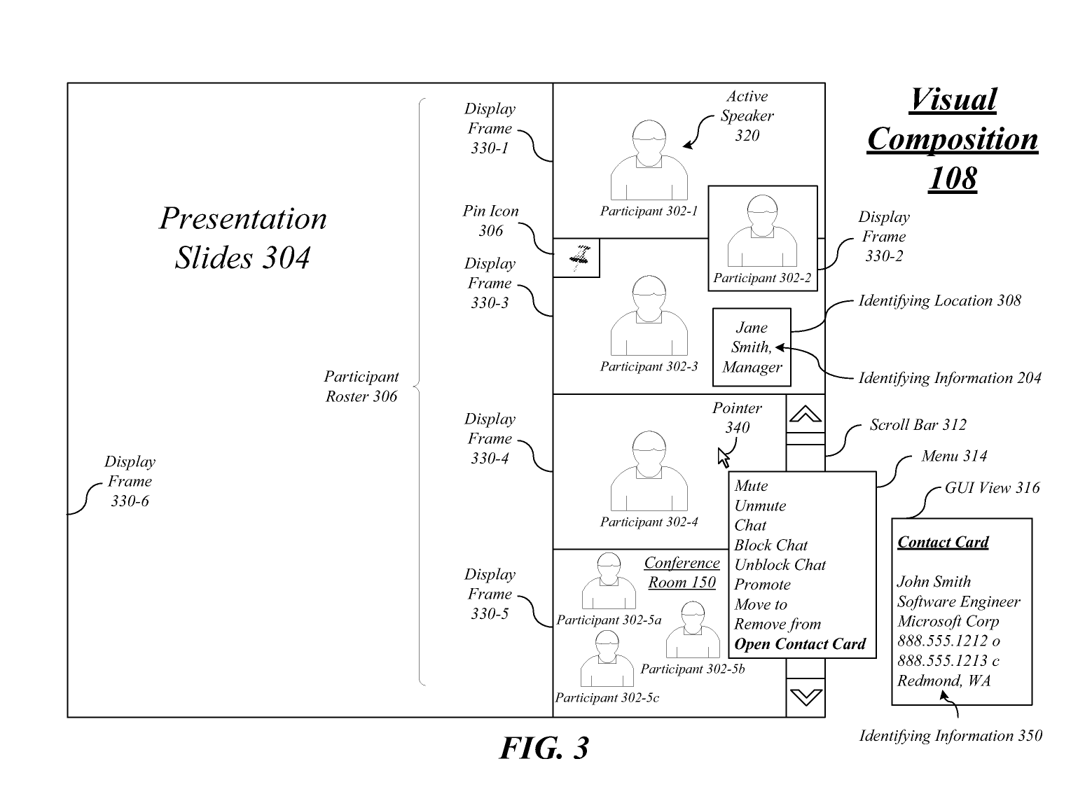

FIG. 3 illustrates a more detailed illustrated of the visual composition 108. The visual composition 108 may comprise various display frames 330-1-a arranged in a certain mosaic or display pattern for presentation to a viewer, such as an operator of a meeting console 110-1-m. Each display frame 330-1-a is designed to render or display multimedia content from the media streams 202-1-f, such as video content and/or audio content from a corresponding media stream 202-1-fmapped to a display frame 330-1-a by the MSM module 230.

In the illustrated embodiment shown in FIG. 3, for example, the visual composition 108 may include a display frame 330-6 comprising a main viewing region to display application data such as presentation slides 304 from presentation application software. Further, the visual composition 108 may include a participant roster 306 comprising the display frames 330-1 through 330-5. It may be appreciated that the visual composition 108 may include more or less display frames 330-1-s of varying sizes and alternate arrangements as desired for a given implementation.

The participant roster 306 may comprise multiple display frames 330-1 through 330-5. The display frames 330-1 through 330-5 may provide video content and/or audio content of the participants 302-1-b from the various media streams 202-1-f communicated by the meeting consoles 110-1-m. The various display frames 330-1 of the participant roster 306 may be located in a predetermined order from a top of visual composition 108 to a bottom of visual composition 108, such as the display frame 330-1 at a first position near the top, the display frame 330-2 in a second position, the display frame 330-3 in a third position, the display frame 330-4 in a fourth position, and the display frame 330-5 in a fifth position near the bottom. The video content of participants 302-1-b displayed by the display frames 330-1 through 330-5 may be rendered in various formats, such as “head-and-shoulder” cutouts (e.g., with or without any background), transparent objects that can overlay other objects, rectangular regions in perspective, panoramic views, and so forth.

The predetermined order for the display frames 330-1-b of the participant roster 306 is not necessarily static. In some embodiments, for example, the predetermined order may vary for a number of reasons. For example, an operator may manually configure some or all of the predetermined order based on personal preferences. In another example, the visual composition component 114-1-t may automatically modify the predetermined order based on participants joining or leaving a given multimedia conference event, modification of display sizes for the display frames 330-1-a, changes to spatial or temporal resolutions for video content rendered for the display frames 330-1-a, a number of participants 302-1-b shown within video content for the display frames 330-1-a, different multimedia conference events, and so forth.

In one embodiment, the visual composition component 114-1-t may automatically modify the predetermined order based on ASD techniques as implemented by the ASD module 220. Since the active speaker for some multimedia conference events typically changes on a frequent basis, it may be difficult for a viewer to ascertain which of the display frames 330-1-a contains a current active speaker. To solve this and other problems, the participant roster 306 may have a predetermined order of display frames 330-1-a with the first position in the predetermined order reserved for an active speaker 320.

The VCG module 240 may be operative to generate the visual composition 108 with the participant roster 306 having an active display frame 330-1 in a first position of the predetermined order. An active display frame may refer to a display frame 330-1-a specifically designated to display the active speaker 320. In one embodiment, for example, the VCG module 240 may be arranged to move a position within the predetermined order for a display frame 330-1-a having video content for a participant designated as the current active speaker to the first position in the predetermined order. For example, assume the participant 302-1 from a first media stream 202-1 as shown in the first display frame 330-1 is designated as an active speaker 320 at a first time interval. Further assume the ASD module 220 detects that the active speaker 320 changes from the participant 302-1 to the participant 302-4 from the fourth media stream 202-4 as shown in the fourth display frame 330-4 at a second time interval. The VCG module 240 may move the fourth display frame 330-4 from the fourth position in the predetermined order to the first position in the predetermined order reserved for the active speaker 320. The VCG module 240 may then move the first display frame 330-1 from the first position in the predetermined order to the fourth position in the predetermined order just vacated by the fourth display frame 330-4. This may be desirable, for example, to implement visual effects such as showing movement of the display frames 330-1-a during switching operations, thereby providing the viewer a visual cue that the active speaker 320 has changed.

Rather than switching positions for the display frames 330-1-a within the predetermined order, the MSM module 230 may be arranged to switch media streams 202-1-fmapped to the display frames 330-1-a having video content for a participant designated as the current active speaker 320. Using the previous example, rather than switching positions for the display frames 330-1, 330-4 in response to a change in the active speaker 320, the MSM module 230 may switch the respective media streams 202-1, 202-4 between the display frames 330-1, 330-4. For example, the MSM module 230 may cause the first display frame 330-1 to display video content from the fourth media stream 202-4, and the fourth display frame 330-4 to display video content from the first media stream 202-1. This may be desirable, for example, to reduce the amount of computing resources needed to redraw the display frames 330-1-a, thereby releasing resources for other video processing operations.

The VCG module 240 may be operative to generate the visual composition 108 with the participant roster 306 having a non-active display frame 330-2 in a second position of the predetermined order. A non-active display frame may refer to a display frame 330-1-a that is not designated to display the active speaker 320. The non-active display frame 330-2 may have video content for a participant 302-2 corresponding to a meeting console 110-1-m generating the visual composition 108. For example, the viewer of the visual composition 108 is typically a meeting participant as well in a multimedia conference event. Consequently, one of the input media streams 202-1-f includes video content and/or audio content for the viewer. Viewers may desire to view themselves to ensure proper presentation techniques are being used, evaluate non-verbal communications signaled by the viewer, and so forth. Consequently, whereas the first position in the predetermined order of the participant roster 306 includes an active speaker 320, the second position in the predetermined of the participant roster 306 may include video content for the viewing party. Similar to the active speaker 320, the viewing party typically remains in the second position of the predetermined order, even when other display frames 330-1, 330-3, 330-4 and 330-5 are moved within the predetermined order. This ensures continuity for the viewer and reduces the need to scan other regions of the visual composition 108.

In some cases, an operator may manually configure some or all of the predetermined order based on personal preferences. The VCG module 240 may be operative to receive an operator command to move a non-active display frame 330-1-a from a current position in the predetermined order to a new position in the predetermined order. The VCG module 240 may then move the non-active display frame 330-1-a to the new position in response to the operator command. For example, an operator may use an input device such as a mouse, touchscreen, keyboard and so forth to control a pointer 340. The operator may drag-and-drop the display frames 330-1-a to manually form any desired order of display frames 330-1-a.

In addition to displaying audio content and/or video content for the input media streams 202-1-f, the participant roster 306 may also be used to display identifying information for the participants 302-1-b. The annotation module 250 may be operative to receive an operator command to annotate a participant 302-1-b in an active display frame (e.g., the display frame 330-1) or non-active display frame (e.g., the display frames 330-2 through 330-5) with identifying information. For example, assume an operator of a meeting console 110-1-m having the display 116 with the visual composition 108 desires to view identifying information for some or all of the participants 302-1-b shown in the display frames 330-1-a. The annotation module 250 may receive identification information 204 from the multimedia conferencing server 130 and/or the enterprise resource directory 160. The annotation module 250 may determine an identifying location 308 to position the identifying information 204, and annotate the participant with identifying information at the identifying location 308. The identifying location 308 should be in relatively close proximity to the relevant participant 302-1-b. The identifying location 308 may comprise a position within the display frame 330-1-a to annotate the identifying information 204. In application, the identifying information 204 should be sufficiently close to the participant 302-1-b to facilitate a connection between video content for the participant 302-1-b and the identifying information 204 for the participant 302-1-b from the perspective of a person viewing the visual composition 108, while reducing or avoiding the possibility of partially or fully occluding the video content for the participant 302-1-b. The identifying location 308 may be a static location, or may dynamically vary according to factors such as a size of a participant 302-1-b, movement of a participant 302-1-b, changes in background objects in a display frame 330-1-a, and so forth.

In some cases, the VCG module 240 (or GUI module for an OS) may be used to generate a menu 314 having an option to open a separate GUI view 316 with identifying information 204 for a selected participant 302-1-b. For example, an operator may use the input device to control the pointer 340 to hover over a given display frame, such as the display frame 330-4, and the menu 314 will automatically or with activation open the menu 314. One of the options may include “Open Contact Card” or some similar label, that when selected, opens the GUI view 316 with identifying information 350. The identifying information 350 may be the same or similar to the identifying information 204, but typically includes more detailed identifying information for the target participant 302-1-b.

The dynamic modifications for the participant roster 306 provide a more efficient mechanism to interact with the various participants 302-1-b in a virtual meeting room for a multimedia conference event. In some cases, however, an operator or viewer may desire to fix a non-active display frame 330-1-a at a current position in the predetermined order, rather than having the non-active display frame 330-1-a or video content for the non-active display frame 330-1-a move around within the participant roster 306. This may be desirable, for example, if a viewer desires to easily locate and view a particular participant throughout some or all of a multimedia conference event. In such cases, the operator or viewer may select a non-active display frame 330-1-a to remain in its current position in the predetermined order for the participant roster 306. In response to receiving an operator command, the VCG module 240 may temporarily or permanently assign the selected non-active display frame 330-1-a to a selected position within the predetermined order. For example, an operator or viewer may desire to assign the display frame 330-3 to the third position with in the predetermined order. A visual indicator such as the pin icon 306 may indicate that the display frame 330-3 is allocated to the third position and will remain in the third position until released.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

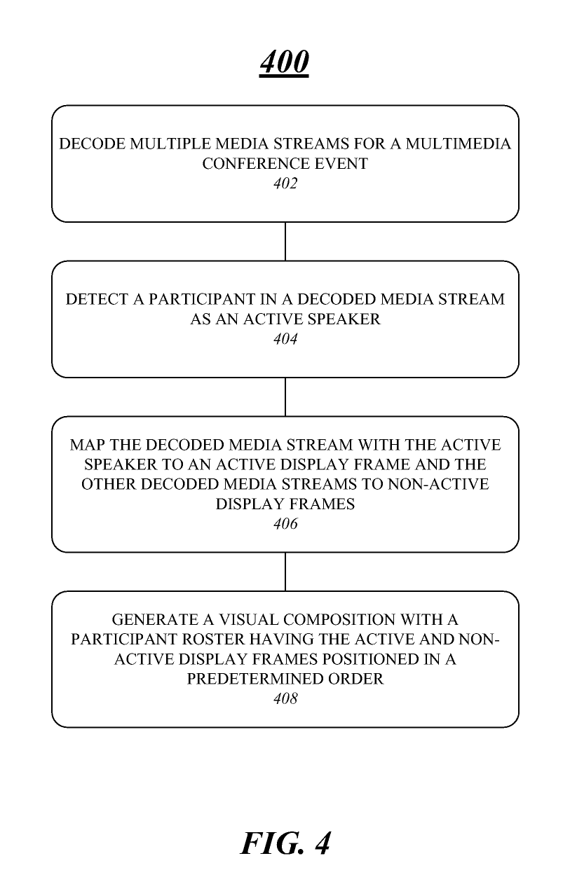

FIG. 4 illustrates one embodiment of a logic flow 400. Logic flow 400 may be representative of some or all of the operations executed by one or more embodiments described herein.

As shown in FIG. 4, the logic flow 400 may decode multiple media streams for a multimedia conference event at block 402. For example, the video decoder module 210 may receive multiple encoded media streams 202-1-f and decode the media streams 202-1-ffor display by the visual composition 108. The encoded media streams 202-1-f may comprise separate media streams, or a mixed media streams combined by the multimedia conferencing server 130.

The logic flow 400 may detect a participant in a decoded media stream as an active speaker at block 404. For example, the ASD module 220 may detect a participant 302-1-b in a decoded media stream 202-1-fis the active speaker 320. The active speaker 320 can, and typically does, frequently change throughout a given multimedia conference event. Consequently, different participants 302-1-b may be designated as the active speaker 320 over time.

The logic flow 400 may map the decoded media stream with the active speaker to an active display frame and the other decoded media streams to non-active display frames at block 406. For example, the MSM module 230 may map the decoded media stream 202-1-fwith the active speaker 320 to an active display frame 330-1 and the other decoded media streams to non-active display frames 330-2-a.

The logic flow 400 may generate a visual composition with a participant roster having the active and non-active display frames positioned in a predetermined order at block 408. For example, the VCG module 240 may generate the visual composition 108 with a participant roster 306 having the active display frame 330-1 and non-active display frames 330-2-a positioned in a predetermined order. The VCG module 240 may modify the predetermined order automatically in response to changing conditions, or an operator can manually modify the predetermined order as desired.

FIG. 5 further illustrates a more detailed block diagram of computing architecture 510 suitable for implementing the meeting consoles 110-1- or the multimedia conferencing server 130. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more application programs 536-1-t and accompanying data. Depending on the implementation, examples of application programs 536-1-t may include server meeting component 132, client meeting components 112-1-n, or visual composition component 114.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

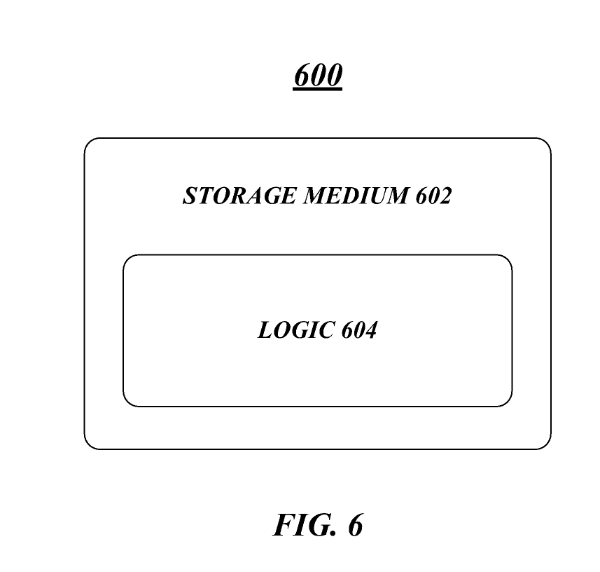

FIG. 6 illustrates a diagram an article of manufacture 600 suitable for storing logic for the various embodiments, including the logic flow 400. As shown, the article 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
decoding multiple media streams for a multimedia conference event;
detecting a participant in a decoded media stream as an active speaker;
mapping the decoded media stream with the active speaker to an active display frame and the other decoded media streams to non-active display frames; and
generating a visual composition with a participant roster having the active and non-active display frames positioned in a predetermined order.

2. The method of claim 1, comprising receiving an operator command to annotate a participant in an active or non-active display frame with identifying information.

3. The method of claim 1, comprising determining an identifying location to position identifying information for a participant in an active or non-active display frame.

4. The method of claim 1, comprising annotating a participant in an active or non-active display frame with identifying information at an identifying location.

5. The method of claim 1, comprising generating a menu having an option to open a separate graphical user interface view with identifying information for a selected participant.

6. The method of claim 1, comprising generating the visual composition with the participant roster having the active display frame in a first position of the predetermined order.

7. The method of claim 1, comprising generating the visual composition with the participant roster having a non-active display frame in a second position of the predetermined order, the non-active display frame having video content for a participant corresponding to a meeting console generating the visual composition.

8. The method of claim 1, comprising moving a non-active display frame from a current position in the predetermined order to a new position in the predetermined order in response to an operator command.

9. The method of claim 1, comprising fixing a non-active display frame at a current position in the predetermined order in response to an operator command.

10. An article comprising a storage medium containing instructions that if executed enable a system to:
decode multiple media streams for a multimedia conference event;
detect a participant in a decoded media stream as an active speaker;
map the decoded media stream with the active speaker to an active display frame and the other decoded media streams to non-active display frames; and
generate a visual composition with a participant roster having the active and non-active display frames positioned in a predetermined order.

11. The article of claim 10, further comprising instructions that if executed enable the system to annotate a participant in an active or non-active display frame with identifying information.

12. The article of claim 10, further comprising instructions that if executed enable the system to generate the visual composition with the participant roster having the active display frame in a first position of the predetermined order.

13. The article of claim 10, further comprising instructions that if executed enable the system to generate the visual composition with the participant roster having a non-active display frame in a second position of the predetermined order, the non-active display frame having video content for a participant corresponding to a meeting console generating the visual composition.

14. The article of claim 10, further comprising instructions that if executed enable the system to move a non-active display frame from a current position in the predetermined order to a new position in the predetermined order in response to an operator command.

15. An apparatus, comprising:
a visual composition component operative to generate a visual composition for a multimedia conference event, the visual composition component comprising:
a video decoder module operative to decode multiple media streams for a multimedia conference event;
an active speaker detector module communicatively coupled to the video decoder module, the active speaker detector module operative to detect a participant in a decoded media stream as an active speaker;
a media stream manager module communicatively coupled to the active speaker detector module, the media stream manager module operative to map the decoded media stream with the active speaker to an active display frame and the other decoded media streams to non-active display frames; and
a visual composition generator module communicatively coupled to the media stream manager module, the visual composition generator module operative to generate a visual composition with a participant roster having the active and non-active display frames positioned in a predetermined order.

16. The apparatus of claim 15, comprising an annotation module communicatively coupled to the visual composition generator module, the annotation module operative to receive an operator command to annotate a participant in an active or non-active display frame with identifying information, determine an identifying location to position the identifying information, and annotate the participant with identifying information at the identifying location.

17. The apparatus of claim 15, comprising the visual composition generator module operative to generate the visual composition with the participant roster having the active display frame in a first position of the predetermined order.

18. The apparatus of claim 15, comprising the visual composition generator module operative to generate the visual composition with the participant roster having a non-active display frame in a second position of the predetermined order, the non-active display frame having video content for a participant corresponding to a meeting console generating the visual composition.

19. The apparatus of claim 15, comprising the visual composition generator module operative to receive an operator command to move a non-active display frame from a current position in the predetermined order to a new position in the predetermined order, and move the non-active display frame to the new position in response to the operator command.

20. The apparatus of claim 15, comprising a meeting console having a display and the visual composition component, the visual composition component to render the visual composition on the display.
